(19) United States
(12) Patent Application Publication
(10) Pub. No.: US 2024/0018753 A1
(43) Pub. Date: Jan. 18, 2024

(54) COUPLING ASSEMBLY

(71) Applicants: AVTRU PTY LTD, BALDIVIS (AU); PEXAN PTY LTD, BALDIVIS (AU)

(72) Inventor: Allen VAUGHAN, BALDIVIS (AU)

(21) Appl. No.: 18/036,216

(22) PCT Filed: Dec. 6, 2021
(86) PCT No.: PCT/AU2021/051451

§ 371 Date: May 10, 2023

(30) Foreign Application Priority Data
Dec. 11, 2020 (AU) 2020904627
Nov. 17, 2021 (AU) 2021903707

(51) Int. Cl. E02F 9/28; F16B 39/28; F16B 37/08

(52) U.S. Cl. CPC E02F 9/2833; E02F 9/2825; F16B 39/28; F16B 37/0807; F16B 37/14

(57) ABSTRACT

A coupling assembly for releasably attaching a ground engaging tool to earth moving equipment comprises a boss arrangement mounted onto a lip of an excavation implement of the equipment relative to an edge of the lip. The coupling assembly also comprises a bolt comprising a threaded portion and a flange. The threaded portion is received by a threaded aperture in the boss arrangement such that relative rotation between the bolt and boss arrangement causes rearward movement of the bolt and flange away from the edge. A retainer is removably insertable between the flange and a bearing surface of the tool readward the flange. The rearward movement causes the flange to engage the retainer and the retainer to engage the bearing surface such that the bolt goes into compression and urges the tool toward the edge.

### Field

The present invention relates to mechanical coupling assemblies and, more particularly, to a coupling assembly for releasably attaching ground engaging tools to earth moving equipment.

### Background

Earth moving vehicles use various different types of excavation mechanisms. Some example mechanisms include dozer blades, articulated excavator arms and front-end and backhoe loaders, These mechanisms typically comprise a tiltable bucket which is manipulated by an operator of the vehicle to excavate earth and rocks, The bucket comprises a lip extending across its base, A series of ground engaging tools (GETs) may be attached to a leading edge of the lip to protect the edge from wear and enable it to penetrate into the ground during use. GETs come in many forms and include metal teeth and shrouds.

GETs are subjected to a range of powerful applied and abrasive forces during use. In particular, when a bucket is driven into hard material such as rock, the GETs receive the impact causing forces to be transferred to the bucket lip. When the bucket is subsequently tilted by the operator, powerful lateral forces act on the GETs. The GETs may eventually be wrenched off from the lip or become damaged or worn over time and need to be replaced.

GETs may be welded onto a bucket lip to secure them in place. This welding method is disadvantageous because the GETs are difficult to remove and replace. A skilled maintenance engineer may need to employ thermal cutting or carbon arc welding techniques to remove the GETs which are time consuming to perform. For underground excavation equipment such as Load Haul Dump (LHD) vehicles, welded-on GETs are particularly inconvenient because thermal cutting and welding methods are often prohibited from being carried out underground. To carry out the maintenance work, the vehicle must be driven above ground which causes significant project downtime and associated productivity losses.

Various mechanical coupling assemblies have been proposed in the past for securing GETs onto bucket lips, such as pin and wedge arrangements. However, these mechanisms all have various shortcomings and are susceptible to damage causing the GETs to come loose during use. When a GET becomes loose, the rate of wear to the GET and its associated coupling assembly increases significantly which leads to rapid GET failure. When a coupling mechanism becomes damaged, a maintenance engineer must use hammers, blow torches and similar tools to remove the remaining parts of the GET and its coupling mechanism from the lip.

The preceding discussion of the background art is intended to facilitate an understanding of the present invention only. The discussion is not an acknowledgement or admission that any of the material referred to is or was part of the common general knowledge as at the priority date of the present application.

### Summary

According to the present invention, there is provided a coupling assembly for releasably attaching a ground engaging tool to earth moving equipment, wherein the coupling assembly comprises:
a boss arrangement mounted onto a lip of an excavation implement of the earth moving equipment relative to an edge of the lip;
a bolt comprising a threaded portion and a flange, wherein the threaded portion is received by a threaded aperture provided in the boss arrangement such that relative rotation between the bolt and boss arrangement causes rearward movement of the bolt and flange away from the edge; and
a retainer that is removably insertable into a position disposed between the flange and a bearing surface of the ground engaging tool rearward of the flange, wherein the rearward movement causes the flange to engage the retainer and the retainer to engage the bearing surface such that the bolt goes into compression and urges the ground engaging tool toward the edge.

The retainer may comprise an aperture that receives a shank of the bolt. The flange may be adapted to engage a frontmost bearing surface of the retainer when the shank is received in the aperture.

The flange may outwardly protrude from a longitudinal axis of the shank and the frontmost bearing surface may comprise a region of the retainer surrounding the aperture provided in the retainer.

The flange may comprise an annular flange member extending circumferentially around the longitudinal axis of the shank.

The frontmost bearing surface of the retainer may comprise an indented egion that is dimensioned to receive the annular flange member.

The aperture provided in the retainer may extend to a lowermost end of the retainer to provide an opening that receives the shank when the retainer is arranged onto the shank.

The retainer may be removably insertable into a slot provided in a portion of the ground engaging tool extending over the lip. The slot may be configured such that the rearward movement of the bolt and flange causes the retainer to bear against an inwardly facing surface of the slot.

The portion of the ground engaging tool extending over the lip may be an uppermost portion of the ground engaging tool that rests on an uppermost surface of the lip when the ground engaging tool is arranged on the lip.

The retainer may comprise a lug that is received into a cavity provided in the slot.

The lug may extend rearward from an uppermost end of the retainer.

The retainer may comprise a lip projecting away from a rearward side of the retainer, wherein the lip is adapted to engage underneath a portion of the ground engaging tool when the retainer bears against the inwardly facing surface of the slot.

The boss arrangement may be a composite arrangement that comprises a nut and a mounting device. The nut may be threadedly connectable to the threaded portion of the bolt. The mounting device may be secured to a surface of the lip and removably receive the nut to secure the nut relative to the lip.

The mounting device may comprise a wall upwardly extending from the surface of the lip, wherein an aperture extends through the wall that receives the shank of the bolt, and wherein the wall is positioned such that the nut bears against the wall when the bolt is turned relative to the nut.

The mounting device may comprise a second wall, wherein the wall and the second wall are spaced apart from each other to provide a cavity therebetween that receives the nut to restrain translational movement of the nut relative to the boss arrangement.

The nut may be dimensioned such that one or more lateral sides of the nut engage with the mounting device or the surface of the lip to restrain rotational movement of the nut.

The end of the bolt that is distal to the threaded portion may comprise a bolt head.

The threaded portion of the bolt and the threaded aperture provided in the boss arrangement may be reverse threaded such the rearward movement occurs then the bolt is rotated in a clockwise direction from a point of view looking towards the edge of the lip from a bolt head of the bolt.

The boll may comprise an annular ring member positioned on the shank such that the retainer is sandwiched between the annular ring member and the flange when the retainer is arranged onto the shank.

The bolt, retainer and boss arrangement may be housed inside a cavity in the ground engaging tool, wherein an opening into the cavity is provided at a rearmost end of the ground engaging tool to provide access to the bolt.

The coupling assembly may further comprise a removable plug for sealing the opening.

### BRIEF DESCRIPTION OF DRAWINGS

Embodiments of the invention will now be described by way of example only with reference to the accompanying drawings, in which:

FIG. 1 is side sectional elevation view of a coupling assembly for releasably attaching a ground engaging tool to earth moving equipment according to an example embodiment of the invention;

FIG. 2 is an isometric sectional view of the coupling assembly taken along line labelled A-A in FIG. 4;

FIG. 3 is a sectional plan view of the coupling assembly;

FIG. 4 is a plan view of the ground engaging tool and earth moving equipment depicted in the preceding Figures;

FIG. 5(a) is a plan view of a retainer of the coupling assembly;

FIG. 5(b) is an isometric view of the retainer;

FIG. 5(c) is a rear elevation view of the retainer;

FIG. 5(d) is a side elevation view of the retainer;

FIG. 6(a) is a front elevation view of a bolt of the coupling assembly;

FIG. 6(b) is a side elevation view of the bolt;

FIG. 6(c) is an isometric view of the bolt;

FIG. 7(a) is a front elevation view of a nut of the boss arrangement of the coupling assembly;

FIG. 7(b) is a plan view of the nut;

FIG. 7(c) is an isometric view of the nut;

FIG. 7(d) is a sectional side elevation view of the nut;

FIG. 8(a) is a plan view of a mounting device of the boss arrangement of the coupling assembly;

FIG. 8(b) is a rear elevation view of the mounting device;

FIG. 8(c) is a side sectional elevation view of the mounting device;

FIG. 8(d) is an isometric view of the mounting device;

FIG. 9(a) is a plan view of a removable plug of the coupling assembly;

FIG. 9(b) is an isometric view of the removable plug;

FIG. 9(c) is a rear elevation view of a removable plug;

FIG. 9(d) is a side elevation view of a removable plug;

FIG. 10 is side sectional elevation view of a coupling assembly for releasably attaching a ground engaging tool to earth moving equipment according to a further example embodiment of the invention;

FIG. 11 is an isometric sectional view of the coupling assembly taken along line labelled A-A in FIG. 13;

FIG. 12 is a sectional plan view of the coupling assembly;

FIG. 13 is a plan view of the ground engaging tool and earth moving equipment of FIG. 10;

FIG. 14 is a plan view of a retainer of the coupling assembly of FIG. 10;

FIG. 15 is an isometric view of the retainer of FIG. 14;

FIG. 16 is a rear elevation view of the retainer of FIG. 14;

FIG. 17 is a side elevation view of the retainer of FIG. 14;

FIG. 18 is a front elevation view of a bolt of the coupling assembly of FIG. 10;

FIG. 19 is a side elevation view of the bolt of FIG. 18;

FIG. 20 is an isometric view of the bolt of FIG. 18;

FIG. 21 is an isometric view of a nut of a boss arrangement of the coupling assembly of FIG. 10, wherein the nut receives the bolt of FIG. 18;

FIG. 22 is a partial side elevation view of a threaded shank of the bolt of FIG. 18;

FIG. 23 is a front elevation view of the nut of FIG. 21;

FIG. 24 is a side elevation view of the nut of FIG. 21;

FIG. 25 is a rear elevation view of a mounting device of a boss arrangement of the coupling assembly of FIG. 10;

FIG. 26 is a side sectional elevation view of the mounting device of FIG. 25;

FIG. 27 is an isometric view of the mounting device of FIG. 25;

FIG. 28 is a plan view of the mounting device of FIG. 25;

FIG. 29 is an isometric view of a removable plug of the coupling assembly of FIG. 10;

FIG. 30 is a rear elevation view of the removable plug of FIG. 29;

FIG. 31 is a side elevation view of the removable plug of FIG. 29;

FIG. 32 is a plan view of the removable plug of FIG. 29;

FIG. 33 is a side elevation view of a seal member of the coupling assembly of FIG. 10;

FIG. 34 is a front elevation view of the seal member;

FIG. 35 is an isometric view of the seal member; and

FIG. 36 is a plan view of the seal member.

### Description of Embodiments

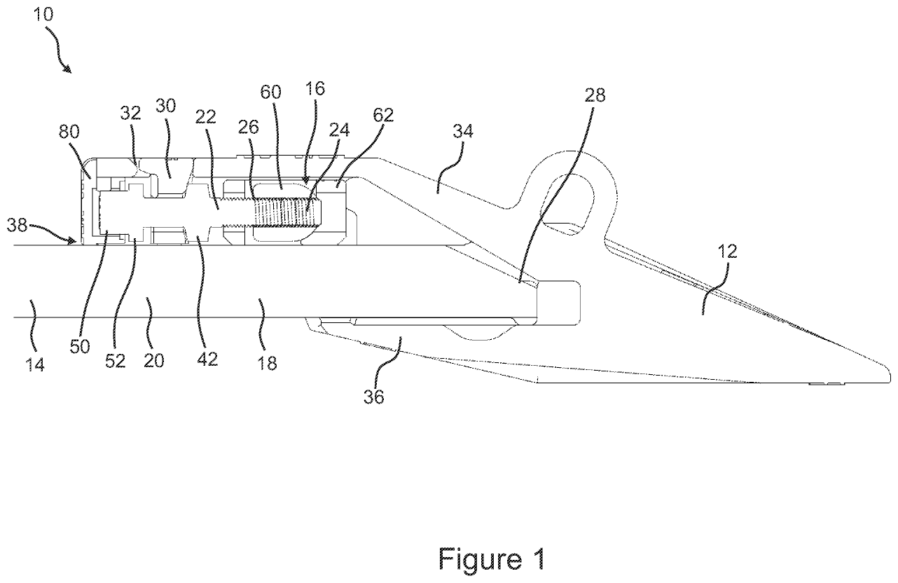

Referring to FIGS. 1 to 3, an example embodiment of the present invention provides a coupling assembly 10 for releasably attaching a ground engaging tool 12 to earth moving equipment 14. The coupling assembly 10 comprises a boss arrangement 16 mounted onto a lip 18 of an excavation implement 20 of the earth moving equipment 14 relative to an edge 28 of the lip 18. The coupling assembly 10 also comprises a bolt 22 comprising a threaded portion 24 and a flange 42, wherein the threaded portion 24 is received by a threaded aperture 26 provided in the boss arrangement 16 such that relative rotation between the bolt 22 and boss arrangement 16 causes rearward movement of the bolt 22 and flange 42 away from the edge 28. The coupling assembly 10 also comprises a retainer 30 that is removably insertable into a position disposed between the flange 42 and a bearing surface 32 of the ground engaging tool 12 rearward of the flange 42. The rearward movement of the bolt 22 and flange 42 away from the edge 28 causes the flange 42 to engage the retainer 30 and the retainer 30 to engage the bearing surface 32 such that the bolt 22 goes into compression and urges the ground engaging tool 12 toward the edge 28.

More particularly, the coupling assembly 10 may be used to attach a range of different ground engaging tools 12 to earth moving equipment 14. In the example depicted, the ground engaging tool 12 comprises a metal shroud of the type that is commonly used to provide wear protection for excavation implements of load haul dump (LHD) vehicles. The example excavation implement 20 that the shroud 12 is attached to comprises a bucket that has a lowermost lip 18. As best shown in FIG. 1, the shroud 12 comprises an uppermost portion 34 and a lowermost portion 36. The two shroud portions 34, 36 are spaced apart from one another and arranged in parallel alignment to define a channel 38 therebetween. The channel 38 is adapted to receive the lip 18 such that the shroud 12 can be slotted rearwardly onto the lip 18.

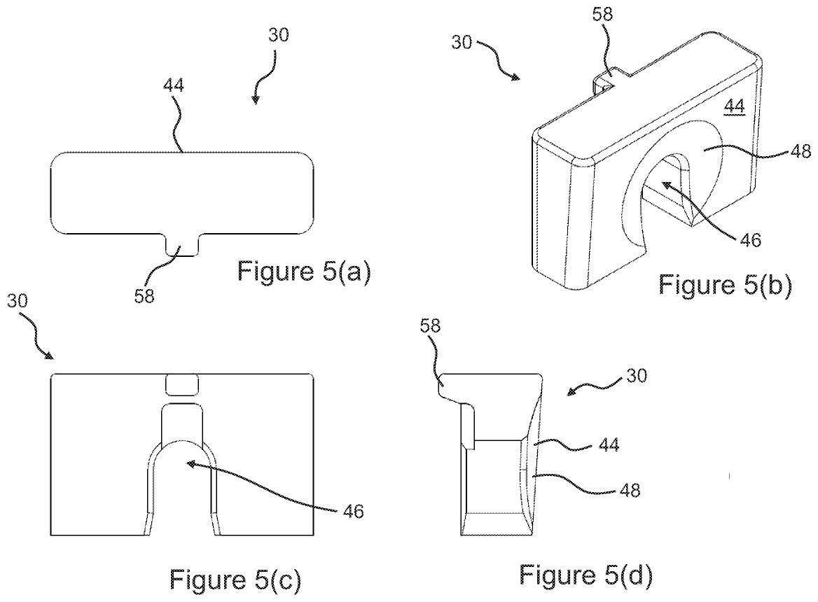

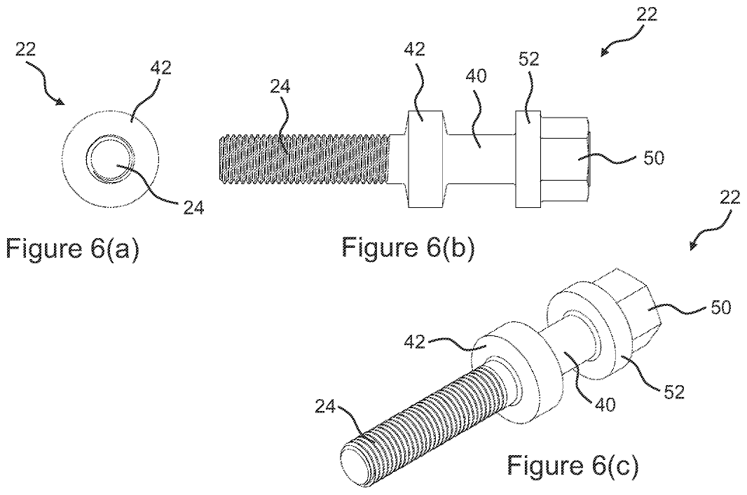

Referring to FIGS. 6(a) to 6(c), the bolt 22 may comprise an elongate shank 40 and the flange 42 may outwardly protrude from a longitudinal axis of the shank 40. The flange 42 may comprise an annular flange member extending circumferentially around a midpoint of the longitudinal axis. As shown in FIGS. 5(a) to 5(d), the retainer 30 may comprise a body that is rectangular in cross section and has a frontmost side that provides a frontmost bearing surface 44. The bearing surface 44 receives and engages with the flange member 42 during use. The retainer 30 may also comprise an aperture 46 extending laterally through the body from the frontmost bearing surface 44 through to an opposed rearmost side of the body. The aperture 46 may extend downward to a lowermost end of the retainer 30 to provide an opening. The opening may be dimensioned to receive the shank 40 of the bolt 22, when the retainer 30 is lowered into the bolt 22, so that the shank 40 extends through the aperture 46. The annular flange member 42 of the bolt 22 may be adapted to engage with the frontmost bearing surface 44 when the shank 40 slides through the aperture 30 during use. The frontmost bearing surface 44 may comprise an indented circular region 48 that surrounds the aperture 46. The indented region 48 may be shaped complementary to the annular shape of the flange member 42 so that the flange member 42 mates with the indented region 48 when received therein.

The threaded portion 24 may be located toward a first end of the shank 40. The bolt 22 may also comprise a bolt head 50 disposed toward a second end of the shank 40 opposed to the first end. The bolt 22 may also comprise an annular ring member 52 spaced apart from the flange member 42 that abuts the bolt head 50. In this arrangement, as best shown in FIG. 1 the ring member 52 is positioned such that when the retainer 30 is arranged onto the shank 40, the retainer 30 is sandwiched between the ring member 52 and the flange member 42. The bolt head 50 may be adapted to engage with a tool that is used to turn the bolt 22 during use. In the example depicted, the bolt head 50 comprises a hexagonal head for engaging with a socket wrench or impact driver. In other examples, the bolt head 50 may comprise a cap nut head, a square nut head or another suitable type of mechanical nut head. The bolt 22 may be made of steel or similar resilient metal-based material.

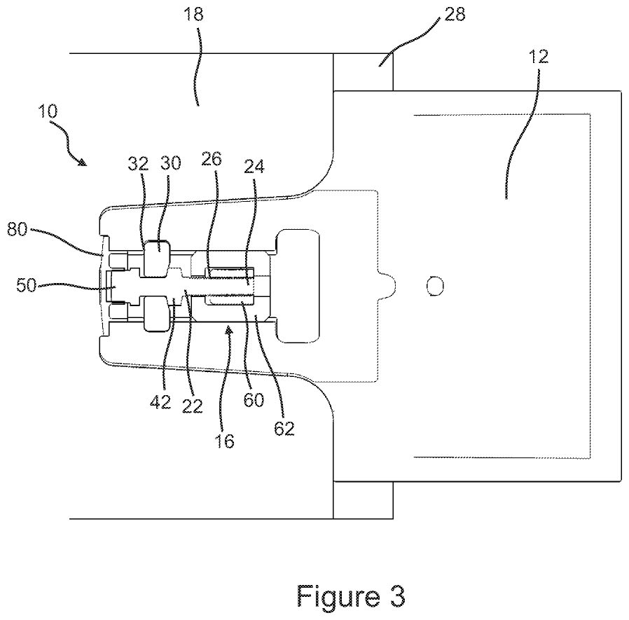

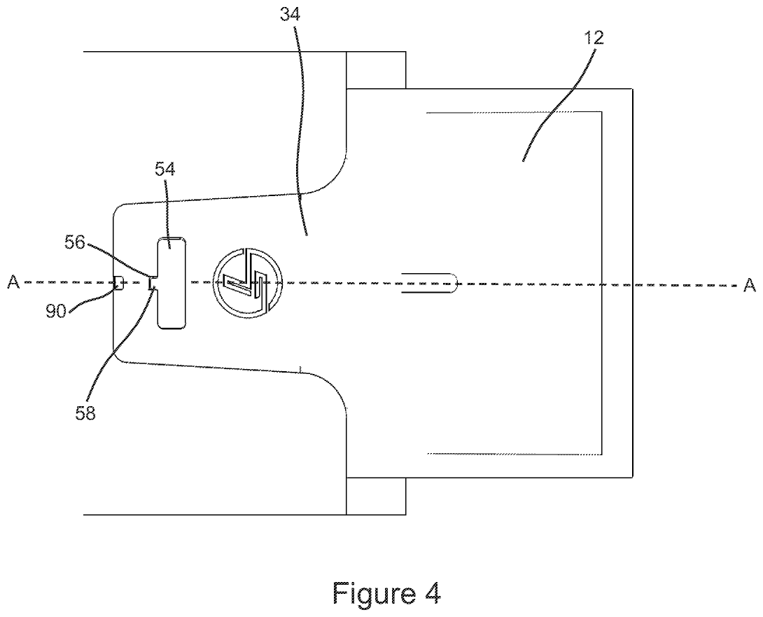

Referring to FIG. 4, the retainer 30 may be dimensioned such that it is removably insertable into a rectangular slot 54 extending vertically through the uppermost portion 34 of the shroud 12. Once inserted, the retainer 30 straddles the shank 40 of the bolt 22 between the ring member 52 and the flange member 42. As best shown in FIG. 3, the retainer 30 may be operatively configured to bear against a rearmost inwardly facing surface 32 of the slot 54 when the bolt 22 is turned relative to the boss arrangement 16 causing the flange member 42 to bear against the retainer 30. The slot 54 may comprise a small cavity 56 provided in an uppermost end of the inwardly facing surface 32. The cavity 56 may receive a lug 58 that extends rearward from an uppermost end of the retainer 30. In other examples, the retainer 30 may have an alternative configuration to the device depicted in FIGS. 5(a)-5(d). For example, the retainer 30 may be a composite assembly that comprises a pair of rigid metal members (not shown) that are insertable into the slot 54 to extend down either side of the shank 40 of the boll 22,

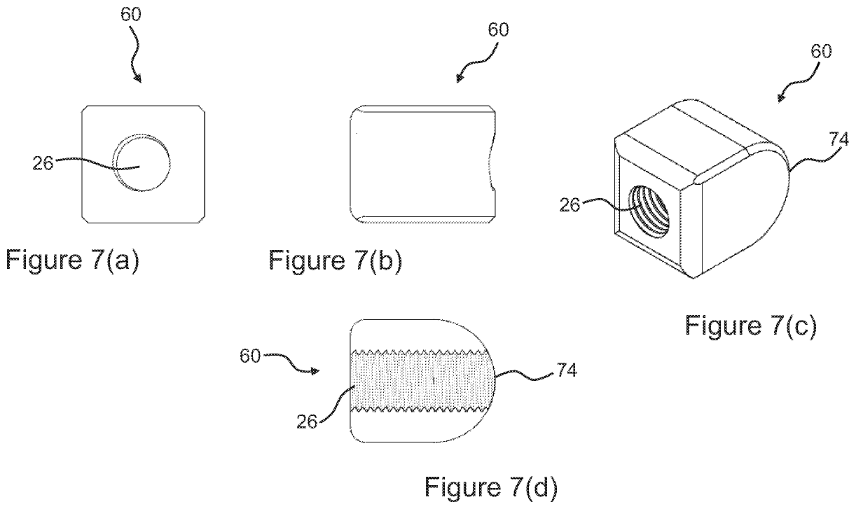

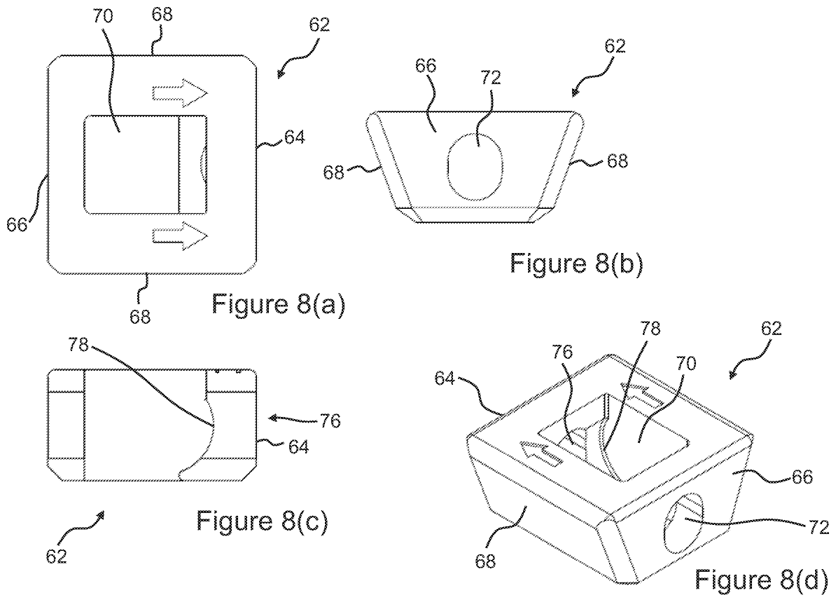

Referring to FIGS. 7(a)-(d) and FIGS. 8(a)-(d), the boss arrangement 16 may be a composite structure that comprises a nut 60 supported by a mounting device 62. The nut 60 may comprise the threaded aperture 26 of the boss arrangement 16 that receives the threaded bolt portion 24. The mounting device 62 may be secured fixedly to an uppermost surface of the lip 18 and operate to hold the nut 60 in place relative to the lip 18. The mounting device 62 may comprise a first wall 64 and a second wall 66 each of which upwardly extend from the surface of the lip 18. The pair of walls 64, 66 may be aligned generally parallel to one another. The mounting device 62 may be oriented on the lip 18 such that its first wall 64 faces the edge 28 of the lip 18 and such that its second wall 66 faces away from the edge 28.

The walls 64, 66 may be spaced apart from one another by a pair of transversely extending side walls 68. The two side walls 68 may upwardly extend from the lip 18 at oblique angles such that the shape of the mounting device 62 resembles an inverted trapezoidal prism. The four walls 64-68 together form a hollow box-like structure and delimit a centrally disposed cavity 70 within the mounting device 62. The cavity 70 receives the nut 60 and impedes translational movement of the nut 60 relative to the lip 18. The mounting device 62 may be fastened to the uppermost surface of the lip 18 using an appropriate attachment means. For example, the mounting device 62 may be welded directly onto the uppermost surface or it may be secured thereto by one or more mechanical fasteners.

The second wall 66 may comprise an aperture 72 extending laterally therethrough that receives the shank 40. The nut 60 may be dimensioned such that when it is held in the cavity 70, one or more of its lateral sides engage with the walls of the mounting device 62, or with the surface of the lip 18 exposed at a base of the cavity 70, to restrain rotational movement of the nut 60. In the example depicted, the nut 60 is substantially box shaped and comprises four lateral sides that function in this manner.

At one end of the nut 60, the uppermost and lowermost sides of the nut 60 may be inwardly tapered to provide a curved end 74. The threaded aperture 26 of the nut 60 may extend longitudinally end to end through to the curved end 74 to provide an opening at the curved end 74. The first wall 64 of the mounting device 62 may comprise an aperture 76 that is provided with a curved inner wall 78 that is complementary to the curved end 74, as depicted in FIG. 8(c). The inner wall 78 is adapted to receive part of the curved end 74 when the nut 60 is held in the cavity 70. When the threaded bolt portion 24 has been screwed into the threaded aperture 26 by a sufficient distance, a peripheral tip of the threaded portion 24 may protrude slightly out of the curved end 74 and extend into the aperture 76 of the first wall 64.

In other examples, the boss arrangement 16 may have an alternative configuration to the composite device depicted in FIGS. 7(a)-(d) and FIGS. 8(a)-(d). For example, the boss arrangement 16 may comprise a single (non-composite) apparatus (not shown) secured fixedly to the uppermost surface of the lip 18 that comprises a threaded bore that receives the threaded bolt portion 24.

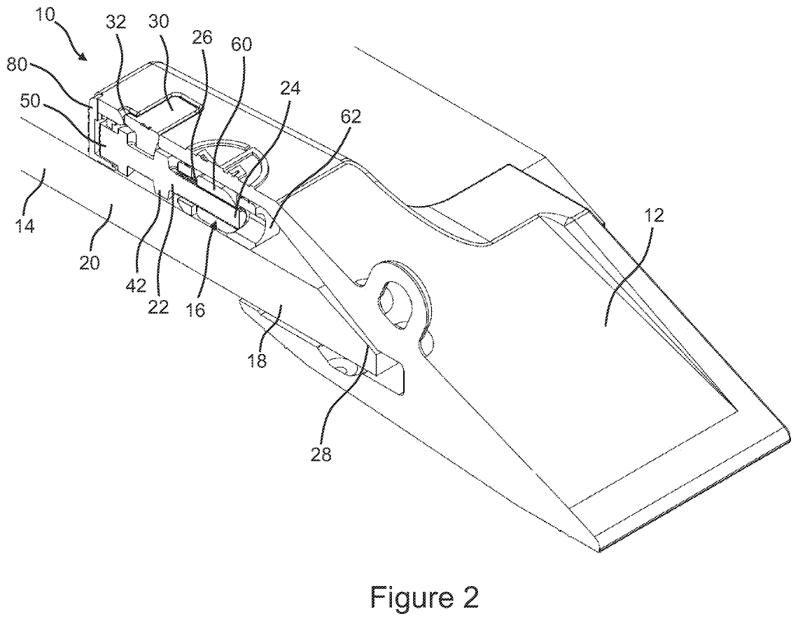

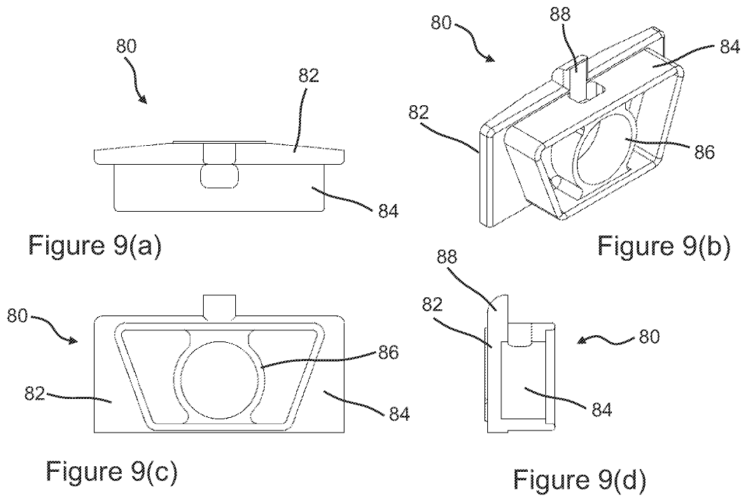

As best shown in FIGS. 1 and 2, the bolt 22, retainer 30 and boss arrangement 16 may all be housed inside the channel 38 of the shroud 12 underneath the uppermost portion 34 of the shroud 12. An opening into the channel 38 may be provided at a rearmost end of the shroud 12 to provide access to the bolt 22. The coupling assembly 10 may also comprise a removable plug 80 for sealing the opening to prevent ingress of dirt, dust, liquids and other unwanted materials and substances into the channel 38. Referring to FIGS. 9(a)-9(d), the plug 80 may comprise a rectangular planar surface 82 that is provided with a flange arrangement 84 on one side. The flange arrangement 84 may comprise a trapezoidal skirt that rearwardly protrudes from the planar surface 82. The skirt 84 may be shaped and oriented such that it is complementary to, and adapted to engage with, an inside surface of the opening into the channel 38.

The plug 80 may also comprise an annular retainer 86 outwardly protruding from the planar surface 82 substantially at a centre of the skirt 84. The retainer 86 may be dimensioned to receive the bolt head 50 when the plug 80 is secured in position. The skirt 84 and retainer 86 may be formed integrally with the plug 80. The plug 80 may be made from rubber, plastic, metal or other suitable material. The plug 80 may have a degree of pliability that enables the plug 80 to be secured to the opening of the channel 38 and stay held in place by interference fit. The plug 80 may also comprise a tab 88 protruding upwardly from its uppermost end that slots into a small cavity 90 (see FIG. 4) provided at the rearmost edge of the uppermost shroud portion 34 when the plug 80 is inserted into the opening. The tab 88 provides a convenient purchase point to facilitate removal of the plug 80 from the opening.

In use, to install the shroud 12 onto the lip 18 the nut 60 may firstly be inserted into the cavity 70 of the mounting device 62 of the boss arrangement 16. The nut 60 is preferably inserted such that its tapered end 74 faces the first wall 64 of the mounting device 62. The shank 40 of the bolt 22 may then be inserted through the aperture 72 provided in the second wall 66 of the mounting device 62 such that its threaded portion 24 enters the threaded bore 26 in the nut 60. With the nut 60 secured in the cavity 70, a socket wrench or similar tool may be connected to the bolt head 50 and used to turn the bolt 22 relative to the boss arrangement 16 to cause the bolt 22 to travel into the nut 60. The threaded portion 24 and the threaded bore 26 may be reverse threaded. In this configuration, the bolt 22 travels into the nut 60 when the bolt 22 is rotated in an anticlockwise direction from a point of view looking towards the edge 28 of the lip 18 from the bolt head 50. The bolt 22 may be turned in this manner until the flange member 42 of the bolt 22 is located at, or close to, the second wall 66 of the mounting device 62.

The shroud 12 may then be offered up onto the lip 18 and pushed rearwardly causing the lip 18 to slide into and through the channel 38. The boss arrangement 16 and bolt 22 pass through the opening at the rearmost end of the channel 38 when the shroud 12 is sliding onto the lip 18. When the shroud 12 is fully on the lip 18, its uppermost and lowermost portions 34, 36 straddle, respectively, the uppermost and lowermost sides of the lip 18. The removable retainer 30 may then be inserted through the rectangular slot 54 in the uppermost portion 34 of the shroud 12. As best shown in FIG. 1, the removable retainer 30 is lowered onto the section of the shank 50 positioned between the flange member 42 and the ring member 52 immediately below the slot 54.

A tool may then be connected again to the bolt head 50 which is accessible via the opening of the channel 38. The bolt 22 may be turned in a clockwise direction from the point of view looking towards the edge 28 from the bolt head 50. Because the threaded portion 24 and threaded bore 26 are reverse threaded, the revolving bolt 22 causes the nut 60 to move towards and engage with the curved inner wall 78 of the mounting device 62. The first wall 64 of the mounting device 62 then operates to restrain any further translational movement of the nut 60 relative to the boss arrangement 16.

As the bolt 22 continues to turn, the reverse threaded bolt end 24 is subsequently caused to travel out of the threaded bore 26 of the nut 60, thus urging the shank 40 towards the retainer 30. The flange member 42 bears against the retainer 30 causing the bolt 22 to go into compression. The retainer 30 engages with the rearmost inner surface 32 of the slot 54 and, in turn, causes the shroud 12 to be urged towards the edge 28 of the lip 18. When the bolt 22 has been sufficiently turned, the retainer 30 effectively locks the shroud 12 in place and the bolt 22 remains in compression. The removable plug 80 may then be inserted into the opening at the rear of the channel 38 to seal the opening and prevent ingress of dirt, dust, liquids and other unwanted materials and substances. The shroud 12 and excavation implement 20 is then ready for use.

Over time, when the shroud 12 has suffered wear and needs to be replaced, the plug 80 may be removed and the bolt 22 may be turned in an anticlockwise direction causing the bolt 22 to travel back into the nut 60. This process removes the compressive forces acting on the bolt 22 and the strong urging force exerted by the bolt's flange member 42 on the retainer 30. The travelling bolt 22 also causes the bolt's annular ring member 52 to bear against the retainer 30 and push the shroud 12 off the lip edge 28 by a small distance to loosen its coupling to the lip 18. The bolt 22 may then be turned in a clockwise direction by a small amount to ensure that the retainer 30 is aligned with the slot 43. The retainer 30 may then be extracted from the slot 54 by inserting the end of screwdriver into the cavity 56 and urging the lug 58 in an upwards direction. With the retainer 30 removed, the shroud 12 may then be pulled off the lip 18.

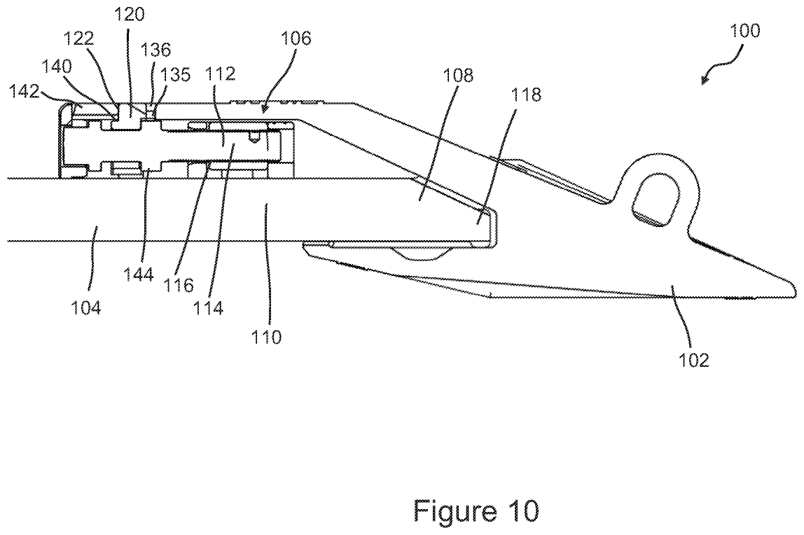

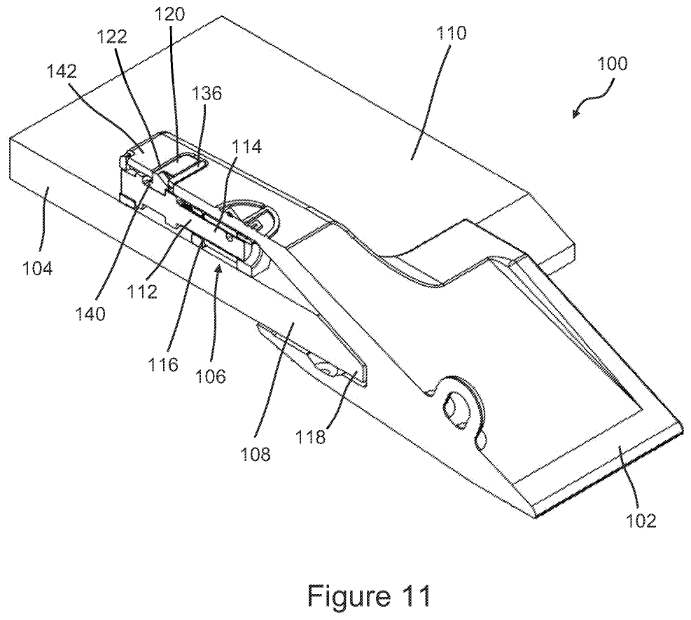

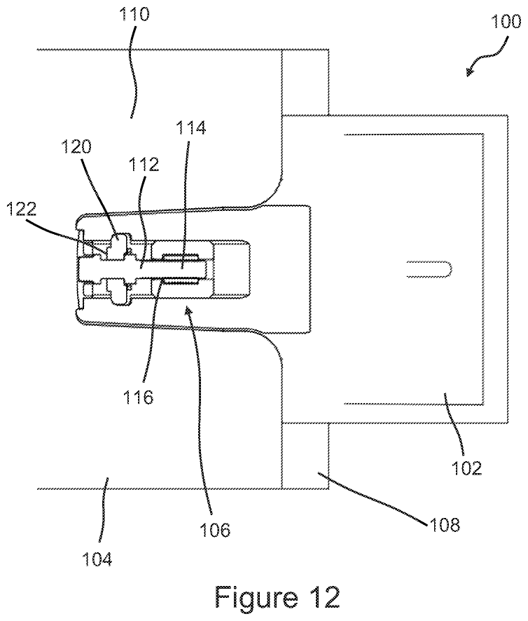

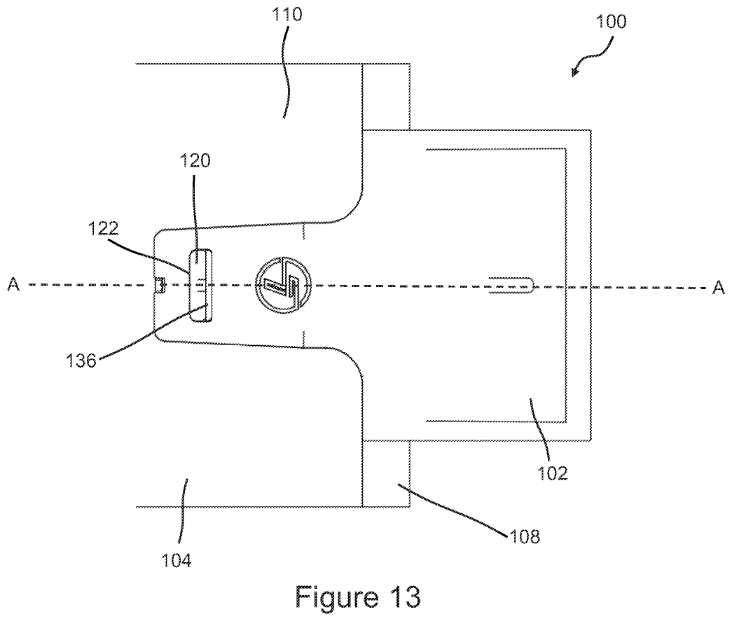

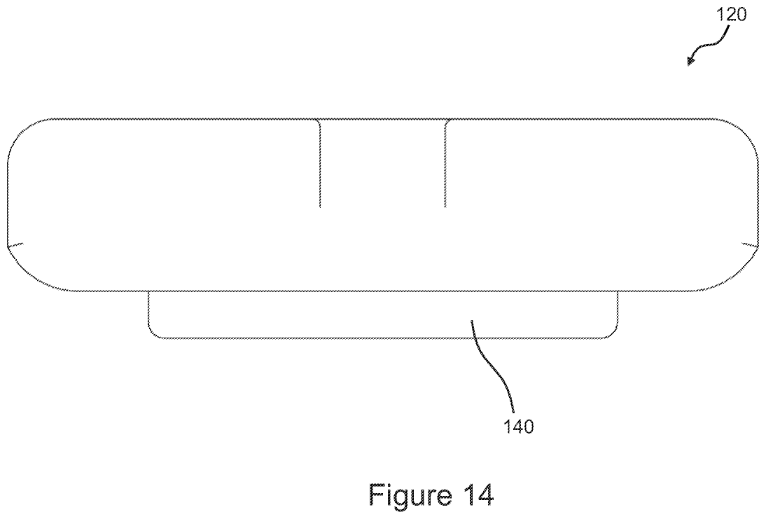

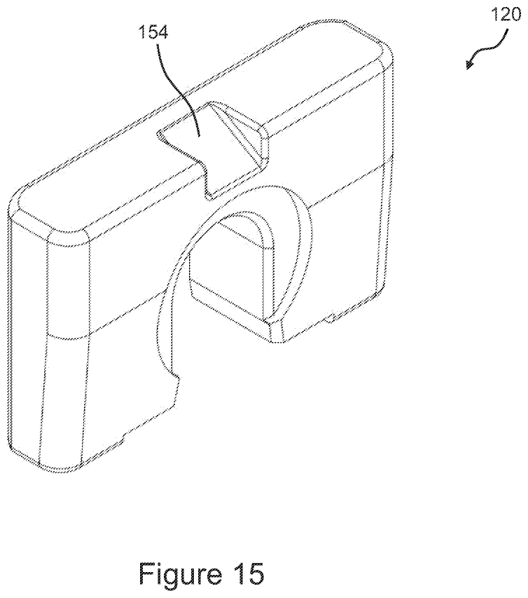

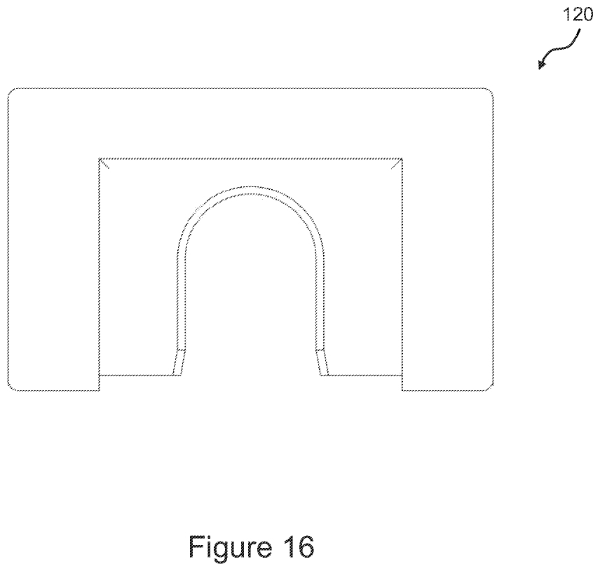

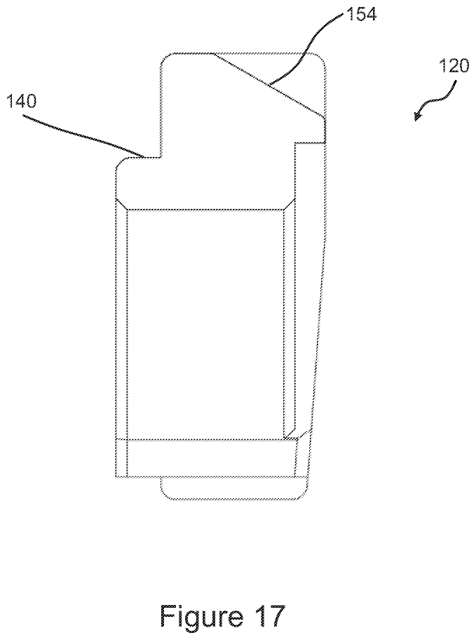

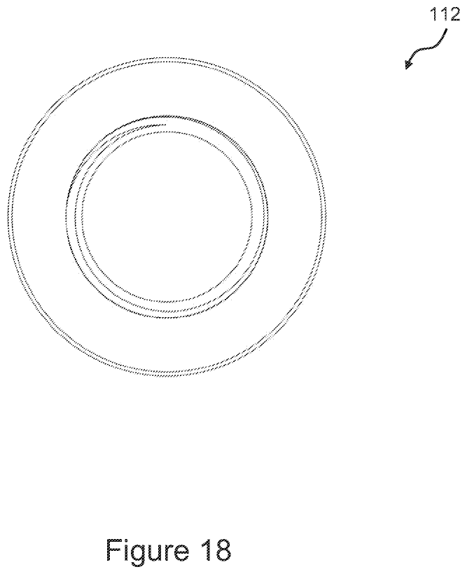

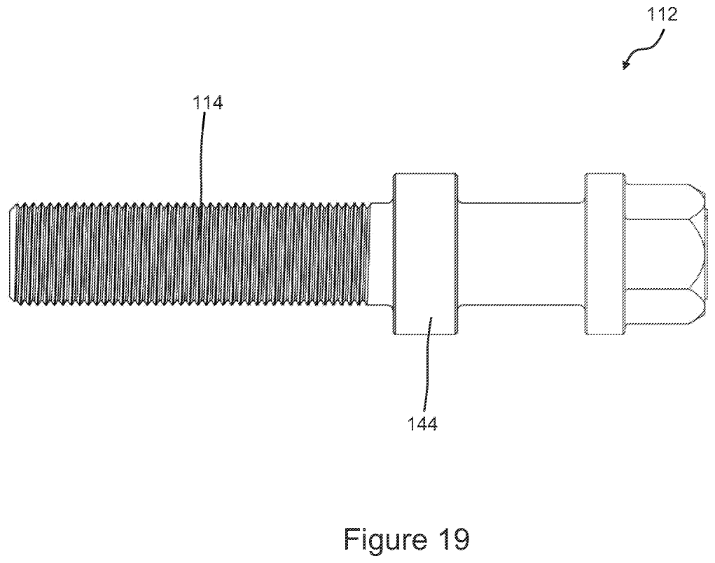

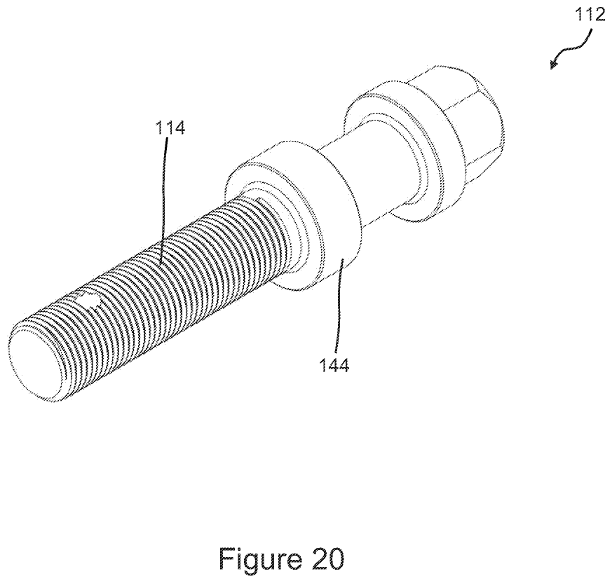

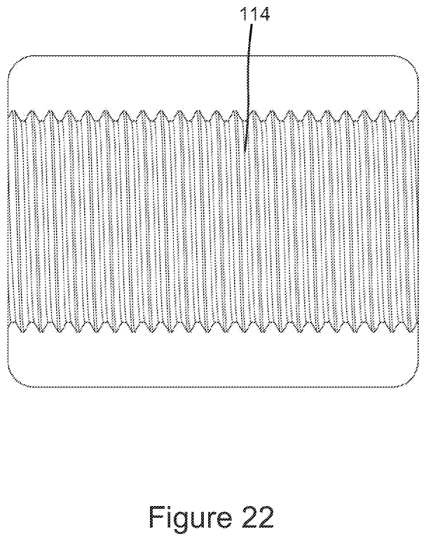

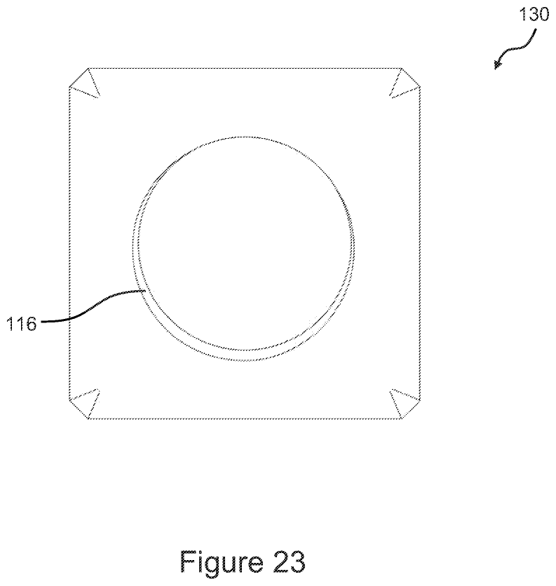

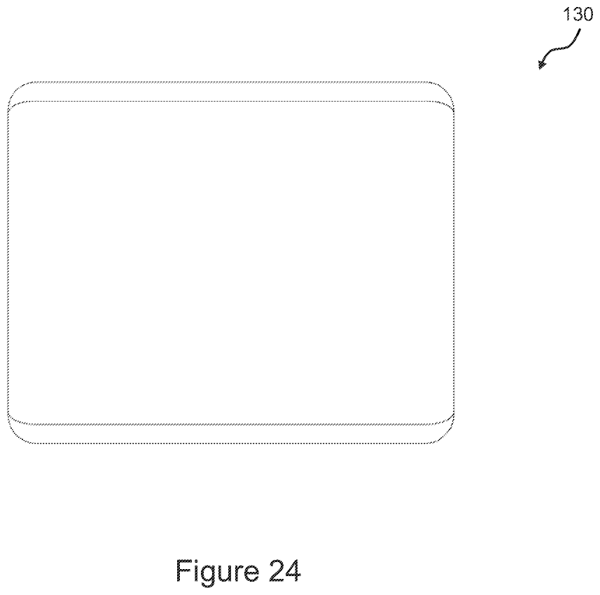

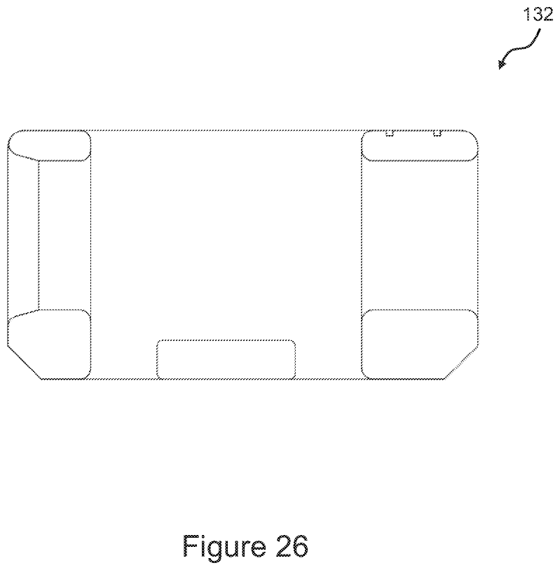

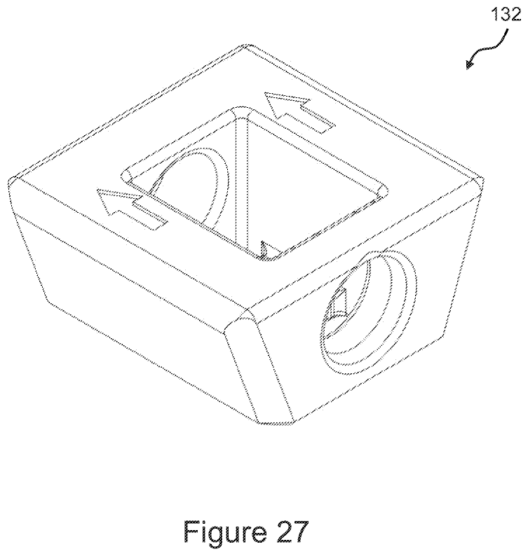

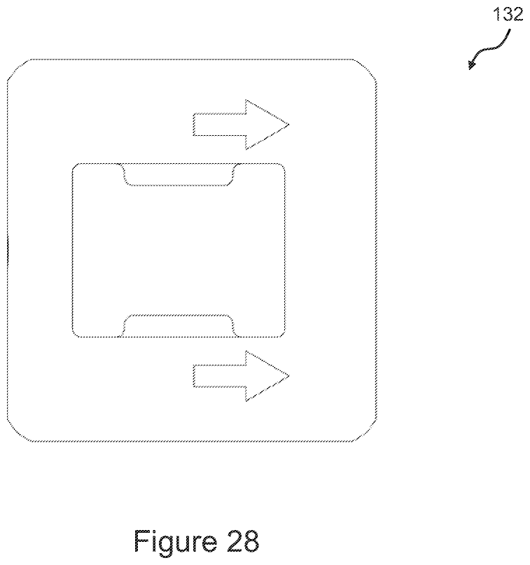

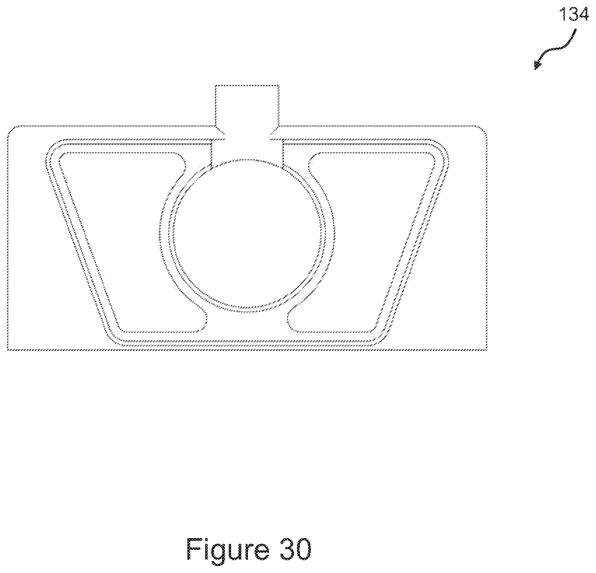

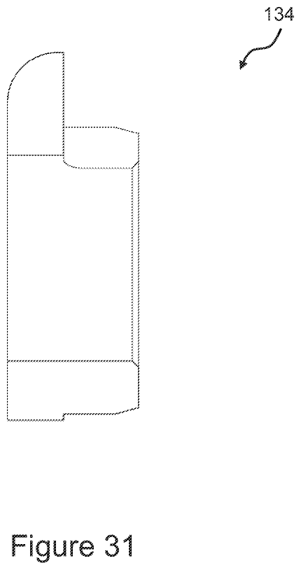

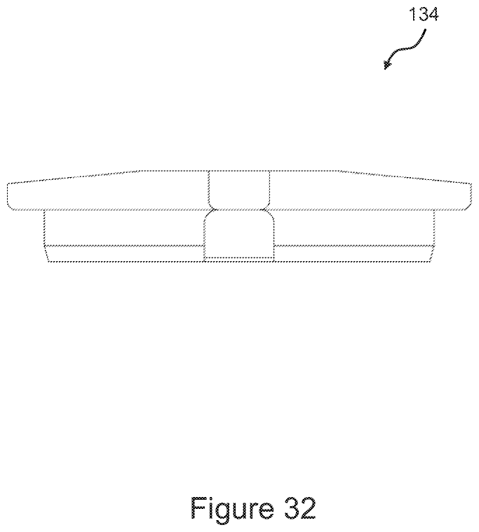

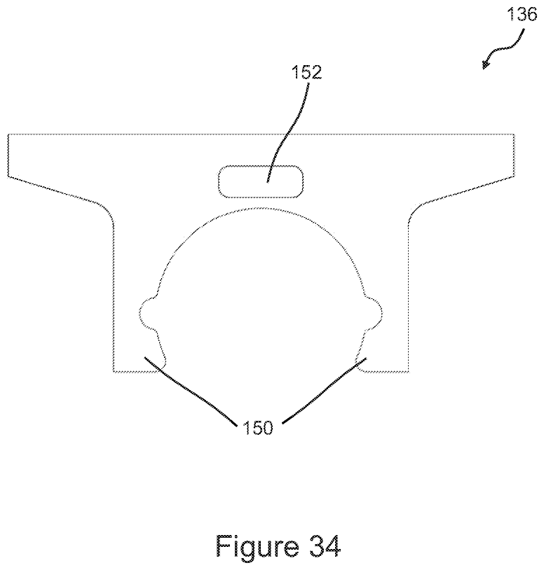

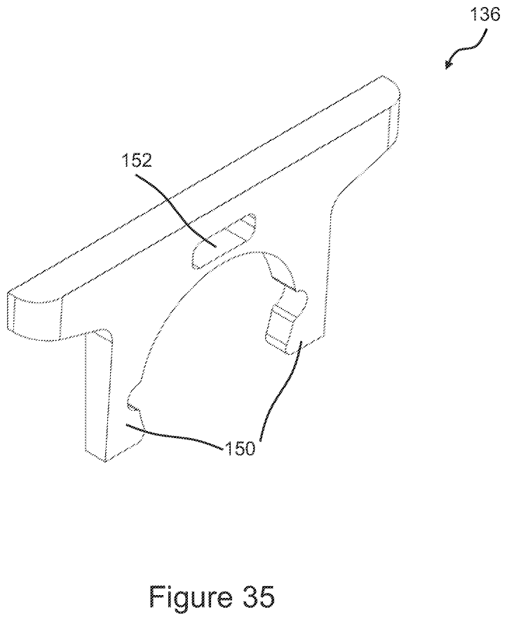

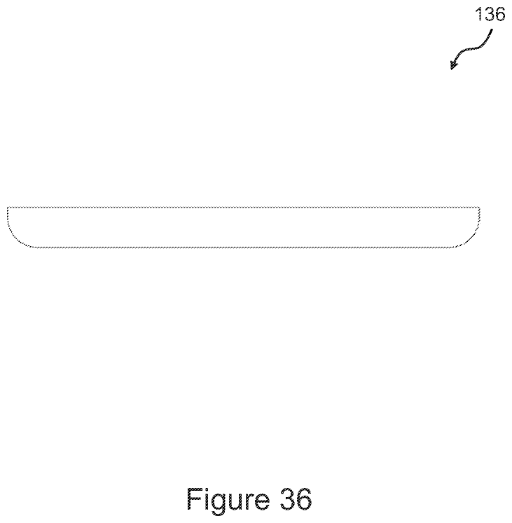

Referring now to FIGS. 10 to 36, a further example embodiment of the present invention provides a coupling assembly 100 for releasably attaching a ground engaging tool 102 to earth moving equipment 104. The coupling assembly 100 comprises a boss arrangement 106 mounted onto a lip 108 of an excavation implement 110 of the earth moving equipment 104 relative to an edge 118 of the lip 108. The coupling assembly 100 also comprises a bolt 112 comprising a threaded portion 114 and a flange 144, wherein the threaded portion 114 is received by a threaded aperture 116 provided in the boss arrangement 106 such that relative rotation between the bolt 112 and boss arrangement 106 causes rearward movement of the bolt 112 and flange 144 away from the edge 118. The coupling assembly 100 also comprises a retainer 120 that is removably insertable into a position disposed between the flange 144 and a bearing surface 122 of the ground engaging tool 102 rearward of the flange 144. The rearward movement of the bolt 112 and flange 144 away from the edge 118 causes the flange 144 to engage the retainer 120 and the retainer 120 to, in turn, engage the bearing surface 122 such that the bolt 112 goes into compression and urges the ground engaging tool 102 toward the edge 118.

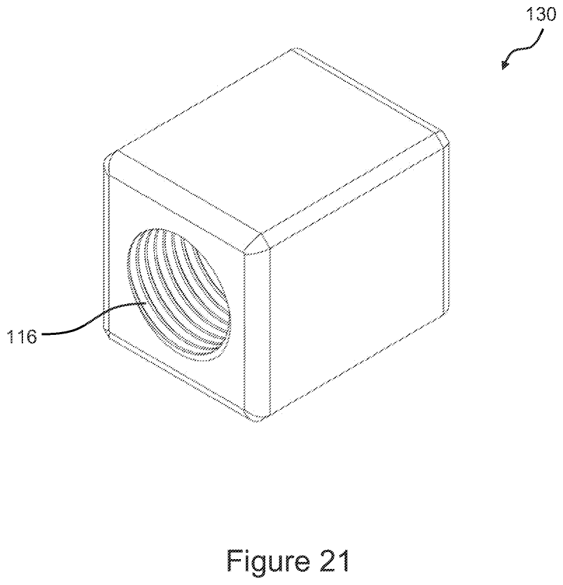

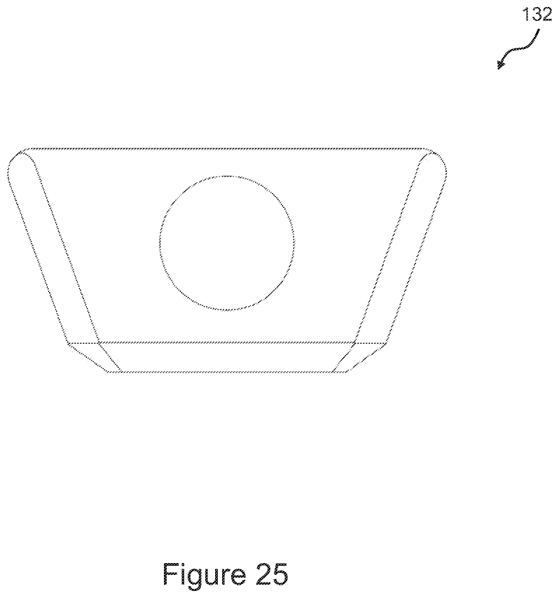

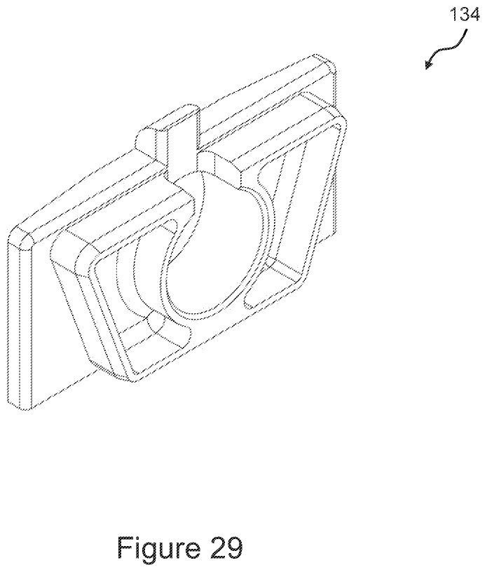

A nut 130 of the boss arrangement 106 is depicted in isolation in FIGS. 21 and 23-24. A mounting device 132 of the boss arrangement 106 is depicted in isolation in FIGS. 25-28. The mounting device 132 receives the nut 130 and restraints rotational and translational movement of the nut 130 relative to the lip 108. A removable plug 134 of the coupling assembly 100 is depicted in isolation in FIGS. 29-32.

The coupling assembly 100 works in materially the same way as the coupling assembly 10 depicted in FIGS. 1 to 3 except that the retainer 120 also comprises a lip 140 projecting away from its rearmost side. As best shown in FIG. 10, the lip 140 is adapted to fit underneath a portion 142 of the ground engaging tool 102 when the tool 102 is attached to the lip 108 by the coupling assembly 100. In use, when the removable retainer 120 is slotted into place and the bolt 112 is turned, the retainer 120 is pushed by the flange 144 of the bolt 112 in a rearward direction away from the edge 118 to engage with the bearing surface 122. In turn, the lip 140 is forced underneath the portion 142 of the ground engaging tool 102 that is positioned behind the retainer 120 and underneath the bearing surface 122.

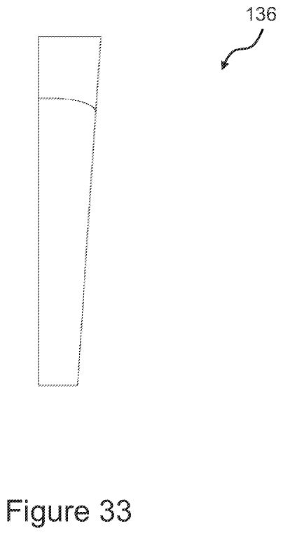

The lip 140 advantageously prevents the retainer 120 from moving in an upward direction away from the bolt 112 when the earth moving equipment 104 is being used, effectively locking the retainer 120 within the slot in the tool 102 that receives the retainer 120. When the lip 140 slides underneath the portion 142 during the attachment of the tool 102, it will be appreciated that a corresponding gap 135 (see FIG. 10) is created in the retainer-receiving slot of the tool 102. The coupling assembly 100 may, therefore, also comprise a seal member 136 that may be pushed into this gap 135. The seal member 136, which is depicted in FIGS. 33 to 36, may be adapted such that it removably engages with the gap 135 by interference fit. The seal member 136 operates to fill the gap 135 to prevent the ingress of dirt, dust and moisture therein. The seal member 136 may comprise a pair of jaws 150 that receive the shank of the bolt 112 when the seal member 136 is pushed into place. The seal member 136 may also comprise an aperture 152 adapted to receive a screw driver blade for lifting the seal member 136 out of the gap 135 when required. The retainer 120 may comprise a cavity 154 formed in its uppermost end that provides access to the aperture 152 from the uppermost surface of the tool 102.

Now that example embodiments of the coupling assembly have been described, it will be apparent that it provides a number of advantages over the prior art, including the following:

(i) The coupling assembly provides a simple, robust, inexpensive and effective mechanism for attaching ground engaging tools to excavation implements;

(ii) The removable retaainer 30 and slot 54 arrangement enables a ground engaging tool 12 to be placed onto the lip 18 without the need for complex mechanical components and fittings. The coupling assembly also avoids the need for pins, wedges and similar fastening devices that require the use of a hammer to drive them in and remove them;

(iii) Because the bolt 22 is aligned orthogonally to the edge 28 of the lip 18 and resides inside the cavity 38, this configuration advantageously avoids the need for the large structural fittings and mounting devices as used in many existing attachment mechanisms that protrude from the lip and are exposed during use;

(iv) The bolt 22, retainer 30 and slot 54 arrangement also enables the upper portion 34 of the ground engaging tool 12 to be relatively short in length. Many existing attachment mechanisms require the upper portion 34 to be substantially larger in order to operate. The quantity of raw materials that are required to construct, install and operate the present coupling assembly are minimised. This reduces throw away wastage costs associated with replacing worn parts. This also reduces the total weight of the coupling assembly compared with prior art systems which reduces the risk of injury occurring during installations and removals;

(v) The location and orientation of the bolt 22 advantageously provides that the bolt 22 is able to withstand bending forces when the bucket 20 is tilted backwards during use causing the ground engaging tool 12 to be loaded in a downwards direction;

(vi) The use of the bolt 22 and boss arrangement 16 advantageously allows the ground engaging tool 12 to be tightened should it become loose over time. This is not possible in many prior art systems, including those that utilise wedges and similar friction-based fastening means. If a ground engaging tool becomes loose, this can rapidly lead to wear on the bucket lip which, in turn, exacerbates further movement of the tool and consequent wear to the lip;

(vii) Because the bolt 22 is put into compression (not tension) when the ground engaging tool 12 is locked onto the lip 18, the bolt 22 is able to withstand significant translational and bending forces during use. If the bolt 22 is in tension, such forces cause fracturing and similar stress damage to the bolt over time ultimately leading to its failure. The bolt 12 is significantly more resilient when subjected to compressive forces.

Embodiments of the present invention provide coupling assemblies that are useful for releasably attaching ground engaging tools, such as shrouds and teeth, to buckets and other excavation implements of earth moving equipment.

For the purpose of this specification, the word “comprising” means “including but not limited to”, and the word “comprises” has a corresponding meaning. It is to be understood that, if any prior art is referred to herein, such reference does not constitute an admission that the prior art forms a part of the common general knowledge in the art, in Australia or any other country.

The above embodiments have been described by way of example only and modifications are possible within the scope of the claims that follow.

1. A coupling assembly for releasably attaching a ground engaging tool to earth moving equipment, wherein the coupling assembly comprises:
a boss arrangement mounted onto a lip of an excavation implement of the earth moving equipment relative to an edge of the lip;
a bolt comprising a flange and an annular member rearwardly spaced from the flange on a shank of the bolt, and wherein a threaded portion of the shank is received by a threaded aperture provided in the boss arrangement such that relative rotation of the bolt relative to the boss arrangement in first and second directions causes the bolt to move away from and toward the edge respectively; and
a retainer removably insertable into a slot in the ground engaging tool to a position disposed between the flange and the annular member,
wherein the rearward movement of the bolt away from the edge causes the flange to engage the retainer and, in turn, causes the retainer to engage the ground engaging tool toward to urge the ground engaging tool toward the edge, and wherein movement of the bolt toward the edge causes the annular member to engage the retainer and, in turn, causes the retainer to engage the ground engaging tool to urge the ground engaging tool away from the edge.

2. The coupling assembly according to claim 1, wherein the retainer comprises an aperture that receives the shank of the bolt, and wherein the flange is adapted to engage a frontmost bearing surface of the retainer.

3. The coupling assembly according to claim 2, wherein the flange outwardly protrudes from a longitudinal axis of the shank, and wherein the frontmost bearing surface comprises a region of the retainer surrounding the aperture provided in the retainer.

4. The coupling assembly according to claim 3, wherein the flange comprises an annular flange member extending circumferentially around the longitudinal axis.

5. The coupling assembly according to claim 4, wherein the frontmost bearing surface comprises an indented region dimensioned to receive the annular flange member.

6. The coupling assembly according to claim 2, wherein the aperture provided in the retainer extends to a lowermost end of the retainer to provide an opening that receives the shank of the bolt when the retainer is arranged onto the shank.

7. The coupling assembly according to claim 1, wherein the slot is provided in a portion of the ground engaging tool extending over the lip, and wherein the slot is configured such that the movement of the bolt away from the edge causes the retainer to bear against an inwardly facing surface of the slot.

8. The coupling assembly according to claim 7, wherein the portion is an uppermost portion of the ground engaging tool that rests on an uppermost surface of the lip when the ground engaging tool is arranged on the lip.

9. The coupling assembly according to claim 7, wherein the retainer comprises a lug that is received into a cavity provided in the slot.

10. The coupling assembly according to claim 9, wherein the lug extends rearward from an uppermost end of the retainer.

11. The coupling assembly according to claim 7, wherein the retainer comprises a lip projecting away from a rearward side of the retainer that is adapted to engage underneath a portion of the ground engaging tool when the retainer bears against the inwardly facing surface of the slot.

12. The coupling assembly according to claim 1, wherein the boss arrangement is a composite arrangement comprising a nut, the nut being threadedly connectable to the threaded portion of the shank, and a mounting device secured to a surface of the lip, wherein the mounting device removably receives the nut to secure the nut relative to the lip.

13. The coupling assembly according to claim 12, wherein the mounting device comprises a wall upwardly extending from the surface of the lip, and wherein an aperture extends through the wall that receives the shank of the bolt, and wherein the wall is positioned such that the nut bears against the wall when the bolt is turned relative to the nut.

14. The coupling assembly according to claim 13, wherein the mounting device comprises a second wall, and wherein the wall and the second wall are spaced apart from each other to provide a cavity therebetween that receives the nut to restrain translational movement of the nut relative to the boss arrangement.

15. The coupling assembly according to claim 12, wherein the nut is dimensioned such that one or more lateral sides of the nut engage with the mounting device or the surface of the lip to restrain rotational movement of the nut.

16. The coupling assembly according to claim 1, wherein an end of the bolt that is distal to the threaded portion comprises a bolt head.

17. The coupling assembly according to claim 1, wherein the threaded portion of the shank and the threaded aperture provided in the boss arrangement are reverse threaded such the rearward movement occurs then the bolt is rotated in a clockwise direction from a point of view looking towards the edge of the lip from a bolt head of the bolt.

18. (canceled).

19. The coupling assembly according to claim 1, wherein the bolt, retainer and boss arrangement are housed inside a cavity in the ground engaging tool, and wherein an opening into the cavity is provided at a rearmost end of the ground engaging tool to provide access to the bolt.

20. The coupling assembly according to claim 19, wherein the coupling assembly further comprises a removable plug for sealing the opening.

21. The coupling assembly according to claim 20, wherein a tab protrudes from an end of the plug that engages into a cavity provided in the ground engaging tool, wherein the tab provides a purchase point for facilitating removal of the plug from the opening.
